(19) United States
(12) Patent Application Publication
(10) Pub. No.: US 2015/0189360 A1
(43) Pub. Date: Jul. 2, 2015

(54) MULTIMEDIA BROADCASTING SYSTEM AND BROADCASTING METHOD TRIGGERED BY CHARGING OPERATION AND POWER TRANSMISSION DEVICE THEREOF

(71) Applicant: Potentia Computing Inc., New Taipei City (TW)

(72) Inventors: Yun-Chung SHEN, New Taipei City (TW); Ping-Chieh CHANG, New Taipei City (TW); Ji-Ciao LUO, New Taipei City (TW); Jin-Wei SHEN, New Taipei City (TW)

(21) Appl. No.: 14/558,251

(22) Filed: Dec. 2, 2014

(30) Foreign Application Priority Data
Dec. 27, 2013 (TW) 102148798

(51) Int. Cl. H04N 21/414; H04N 21/81; H04N 21/441; H04N 21/41; H04N 21/443

(52) U.S. Cl. CPC H04N 21/41407; H04N 21/4126; H04N 21/4436; H04N 21/441; H04N 21/812; H04N 21/8113

(57) ABSTRACT

A multimedia broadcasting system triggered by a charging operation includes a multimedia device and a power transmission device. The power transmission device includes a discharging connector and a control unit. When the multimedia device is connected to the discharging connector, the control unit transmits readable identification information to the multimedia device via the discharging connector to trigger the multimedia device to play digital content data corresponding to the identification information. Thus, by triggering the multimedia to play advertisements or music via a charging operation, the present invention achieves a novel multimedia broadcasting method.

### BACKGROUND OF THE INVENTION

a) Field of the Invention

The invention relates in general to a multimedia broadcasting system and broadcasting method and a power transmission device thereof, and more particularly, to a multimedia broadcasting system and broadcasting method triggered by a charging operation and a power transmission device thereof.
b) Description of the Prior Art

With progressing economics and highly developed information technologies, various multimedia devices are essential accessories that people carry everywhere in the daily lives. For example, smart phones and tablet computers are popular multimedia devices as sources of different types of information.

Among numerous approaches for providing different types of information to multimedia device users, there is a charging station capable of broadcasting advertisements. While a user utilizes a charging station to charge a multimedia device, the user may read advertisement contents broadcasted by lightboxes or liquid-crystal displays (LCDs) in the charging station.

Such charging station capable of broadcasting advertisements needs to be additionally provided with a broadcasting device. Not only installation costs of hardware are posed on a multimedia provider that wishes to broadcast advertisement through the charging station, but also information is broadcasted to only users utilizing the charging station. Thus, publicity effects of the above broadcasting method are quite limited.

Therefore, there is a need for a multimedia broadcasting system and broadcasting method for reducing publicity costs of multimedia providers and offering users with another method for obtaining various kinds of information.

### SUMMARY OF THE INVENTION

The present invention is directed to a multimedia broadcasting system and broadcasting method triggered by a charge operation and a power transmission device thereof. When a multimedia device is connected to the power transmission device, the power transmission device transmits readable identification information to the multimedia device to trigger the multimedia device to start playing advertisements or music, thereby achieving a novel multimedia broadcasting method.

The present invention provides a multimedia broadcasting system triggered by a charging operation. The multimedia broadcasting system includes a multimedia device and a power transmission device. The power transmission device includes: a discharging connector, being adapted to connect to the multimedia device; and a control unit, connected to the discharging connector, configured to transmit readable identification information to the multimedia device via the discharging connector to trigger the multimedia device to play digital content data corresponding to the identification information.

The present invention further provides a multimedia broadcasting method triggered by a charging operation. The multimedia broadcasting method includes: providing a multimedia device and a power transmission device, the power transmission device including a discharging connector and a control unit, the control unit storing identification information that is readable by the multimedia device; transmitting the identification information, the control unit transmitting the identification information to the multimedia device via the discharging connector when the discharging connector is connected to the multimedia device; and playing digital content data, the identification information triggering the multimedia device to play the digital content data corresponding to the identification information.

The present invention further provides a power transmission device for a multimedia broadcasting system. The power transmission device includes: a discharging connector; and a control unit, storing identification information, electrically signally connected to the discharging connector, configured to output the identification information via the discharging connector. The identification information corresponds to digital content data.

The multimedia broadcasting system and method and the power transmission thereof of the present invention accomplish following effects.

1. A novel multimedia broadcasting method is achieved by triggering the multimedia broadcasting device to play digital content data through a charging operation.

2. Different types of information are provided by the multimedia device to a user during the idle period while the multimedia device is being charged.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a system block diagram of a multimedia broadcasting system triggered by a charging operation according to an embodiment of the present invention;

FIG. 2 is a system block diagram of a multimedia broadcasting system triggered by a charging operation according to another embodiment of the present invention;

FIG. 3 is a system block diagram of a multimedia broadcasting system triggered by a charging operation according to another embodiment of the present invention;

FIG. 4 is a flowchart of a process of a multimedia broadcasting method according to an embodiment of the present invention;

FIG. 5 is a flowchart of a process further including updating digital content data according to an embodiment of the present invention;

FIG. 6 is a flowchart of a process further including downloading a multimedia broadcasting application program and updating digital content data according to an embodiment of the present invention;

FIG. 7 is a flowchart of a process further including downloading multimedia content data according to an embodiment of the present invention; and

FIG. 8 is a flowchart of a process further including downloading a multimedia broadcasting application program and downloading multimedia content data according to an embodiment of the present invention.

### DETAILED DESCRIPTION OF THE PREFERRED EMBODIMENTS

The above and other aspects of the invention will become better understood with regard to the following detailed description of the preferred but non-limiting embodiments. The following description is made with reference to the accompanying drawings.

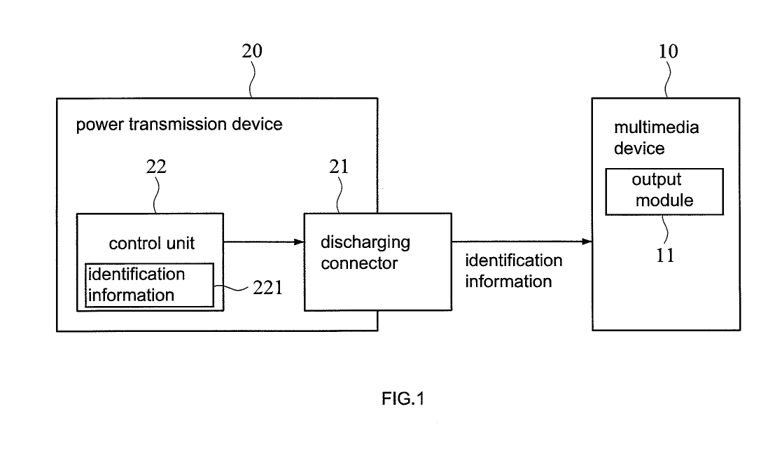

As shown in FIG. 1, according to an embodiment of the present invention, a multimedia broadcasting system triggered by a charging operation includes a multimedia device 10 and a power transmission device 20.

The multimedia device 10 may be a smart phone, a tablet computer, a wearable mobile device, or a device including an output module 11 for displaying an image or playing an audio. For example, the output module 11 includes an audio source output unit, an image output unit or a display screen.

The power transmission device 20 may be a power transmission line, a power adapter, a power bank, a fixed charger (e.g., a charging dock), a travel power transmission device (e.g., a travel charger), or a vehicle power transmission device (e.g., a vehicle charger).

The power transmission device 20 includes a discharging connector 21 and a control unit 22.

The discharging connector 21 is adapted to connect to the multimedia device 10, and may be in different specifications in response to the type of the power transmission device 20. The discharging connector 21 is connectable to the multimedia device 10 to allow data transmission and charging of the multimedia device 10. For example, the discharging connector 21 is a USB (Universal Serial Bus) expansion port, an RS232 port that integrates power supplies, or a Thunderbolt port.

The control unit 22 may be a microprocessor, and is written with or stores identification information 221. The identification information 221 has a content format designed to adapt to a system of the multimedia device 10, and is readable and executable by the multimedia device 10.

The identification information 221 corresponds to digital content data provided by different multimedia providers. The digital content data may include at least one of advertisement data and music data.

The control unit 22 is electrically signally connected to the discharging connector 21. When the multimedia device 10 is connected to the discharging connector 21 of the power transmission device 20, the control unit 22 outputs and transmits readable identification information to the multimedia device 10 via the discharging connector 21, to further trigger the multimedia device 10 to play digital content data corresponding to the identification information. The digital content data is previously downloaded or stored into the multimedia device 10.

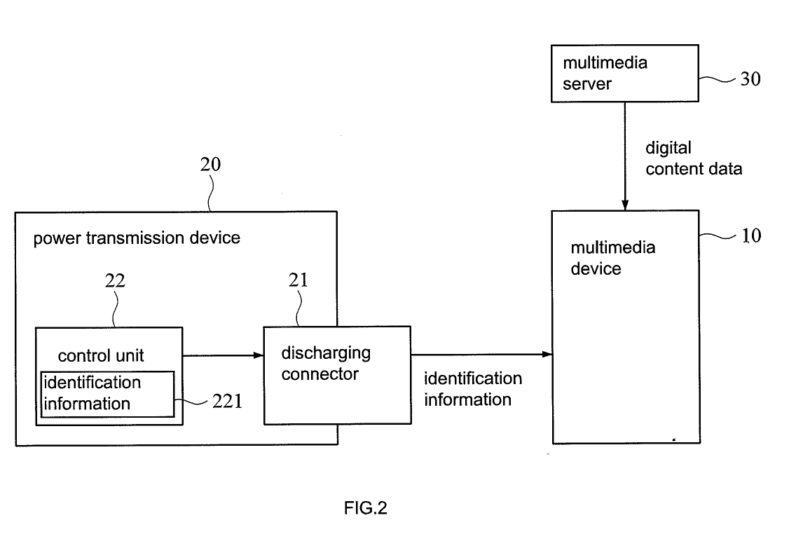

As shown in FIG. 2, the digital content data may also be downloaded from a multimedia server 30 according to the identification information after the multimedia device 10 is triggered by the identification information. The multimedia server 30 stores a plurality of sets of digital content data, which may be provided by multiple different providers. According to contents of the identification information received, the multimedia device 10 downloads and plays only the digital content data corresponding to the identification information.

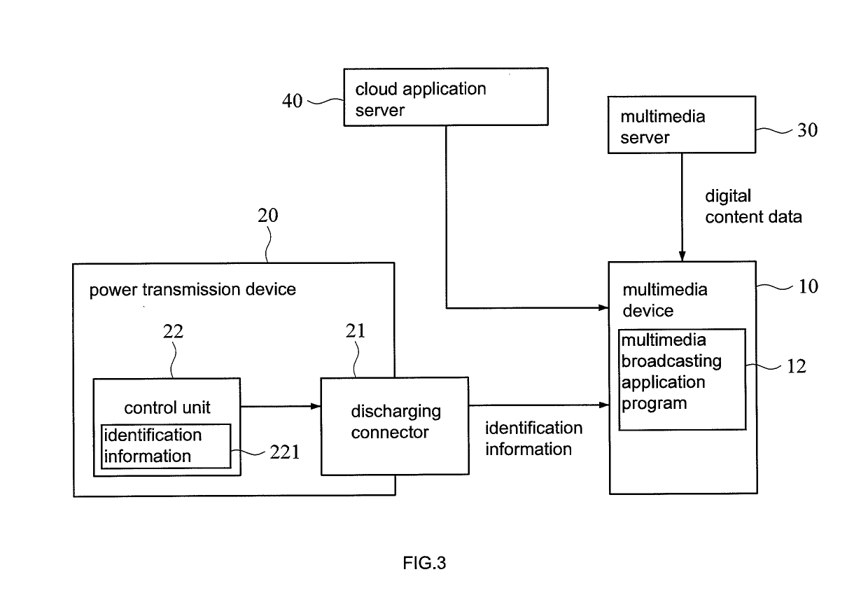

As shown in FIG. 3, in the foregoing embodiments, the multimedia device 10 may play the digital content data by using a multimedia broadcasting application program 12. The multimedia broadcasting application program 12 may be an executable application on the multimedia device 10, and may be triggered by the identification information to start playing the digital content data that is previously downloaded or stored in the multimedia device 10.

Alternatively, after being triggered by the identification information and having read the contents of the identification information, the multimedia broadcasting application program 12 connects to the multimedia server 30 according to the identification information, downloads the digital content data corresponding to the identification information from the multimedia server 30, and plays the downloaded digital content data.

The multimedia broadcasting application program 12 may be installed in the multimedia device 10 in advance, e.g., installed when the multimedia device 10 is shipped out of the factory or installed when the user previously utilizes the multimedia device 10.

If the multimedia device 10 is not installed with the multimedia broadcasting application program 12, when the multimedia device 10 is triggered by the identification information, the multimedia device 10 may automatically connect to a corresponding cloud application server 40 according to the identification information, and download the multimedia broadcasting application program 12 from the cloud application program server 40 to the multimedia device 10.

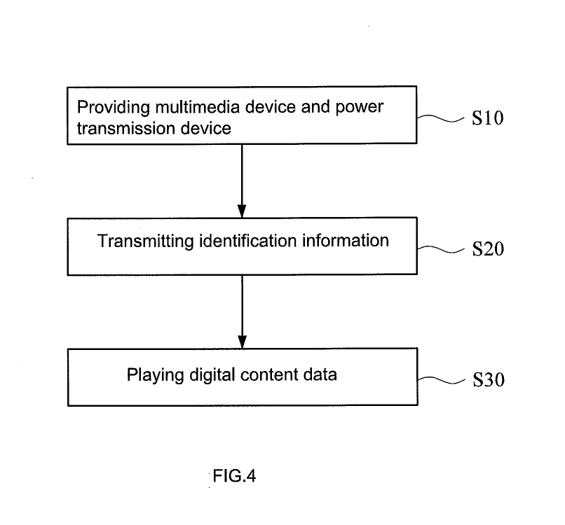

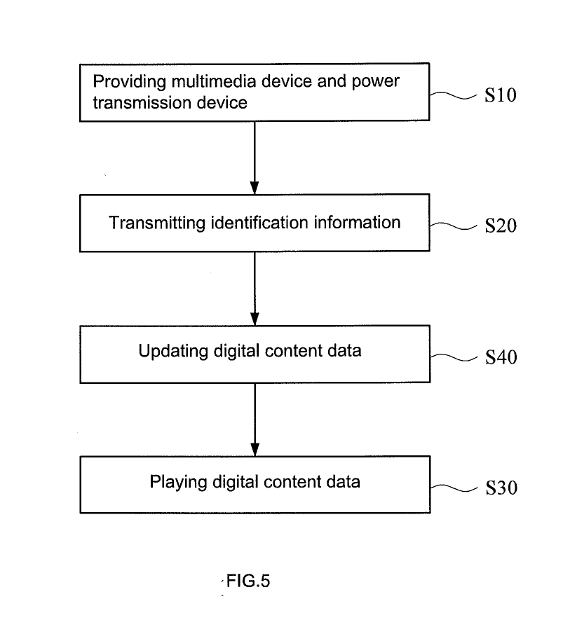

With reference to the abovementioned multimedia broadcasting system and FIG. 1 to FIG. 5, a multimedia broadcasting method triggered by a charging operation according to an embodiment of the present invention is described below. The multimedia broadcasting method includes steps of: providing a multimedia device and a power transmission device (step S10); transmitting identification information (step S20); and playing digital content data (step S30).

In step S10, the multimedia device and the power transmission device are provided. The multimedia device 10 may be a device including an output module 11 for displaying an image or playing an audio. The power transmission device 20 may be a power transmission line, a power adapter, a power bank, a fixed charger (e.g., a charging dock), a travel power transmission device (e.g., a travel charger), or a vehicle power transmission device (e.g., a vehicle charger). Further, the power transmission device 20 includes a discharging connector 21 and a control unit 22. The control unit 22 stores identification information that is readable by the multimedia device 10. Details of the multimedia device 10 and the power transmission device 20 are given above, and shall be omitted herein.

In step S20, the identification information is transmitted. When the power discharging connector 21 is connected to the multimedia device 10, the control unit 22 transmits the identification information to the multimedia device 10 via the discharging connector 21.

In step S30, the digital content data is played. After receiving the identification information, the multimedia device 10 is triggered by the identification information to start playing the digital content data corresponding to the identification information. The digital content data may be previously downloaded or stored into the multimedia device 10.

A multimedia broadcasting application program 12 may be installed in the multimedia device 10 in advance. After the multimedia device 10 receives the identification information, the multimedia broadcasting application program 12 may be triggered to play the digital content data through the multimedia broadcasting application program 12.

As shown in FIG. 1 to FIG. 3 and FIG. 5, the multimedia broadcasting method may further include updating the digital content data (step S40). Before playing the digital content data (step S30), the multimedia broadcasting application program 12 first connects to the multimedia server 30, and compares the digital content data previously downloaded or stored in the multimedia device 10 with the digital content data stored in the multimedia server 30. When the comparison shows a mismatching comparison result, it means that the digital content data corresponding to the identification information has been updated. Thus, the latest digital content data stored in the multimedia server 30 is downloaded to replace the digital content data previously downloaded or stored in the multimedia device 10, thereby updating the digital content data.

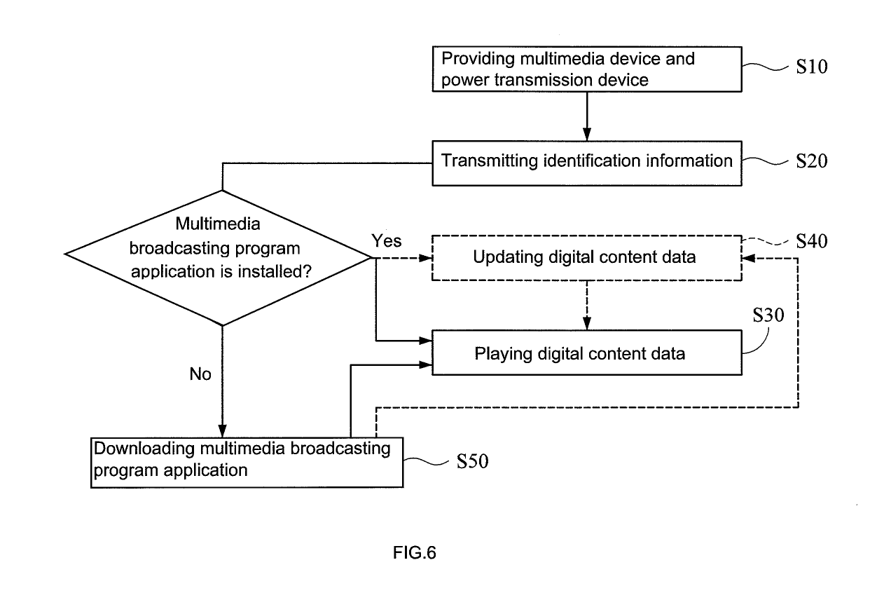

As shown in FIG. 1 to FIG. 3 and FIG. 6, the multimedia broadcasting method may further include downloading a multimedia broadcasting application program (step S50). After the multimedia device 10 receives the identification information, and before the digital content data is updated (step S40) or the digital content data is played (step S30), the multimedia device 10 first determines whether it is installed with the multimedia broadcasting application program 12. If the multimedia device 10 is installed with the multimedia broadcasting application program 12, the step of updating the digital content data (step S40) or playing the digital content data (step S30) is then performed.

If the multimedia device 10 is not installed with the multimedia broadcasting application program 12, the multimedia device 10 may connect to the cloud application server 40, download the multimedia broadcasting application program 12 from the cloud application server 40, and perform the step of updating the digital content data (step S40) or playing the digital content data (step S30). For example, the cloud application server 40 is an application store corresponding to the multimedia device 10.

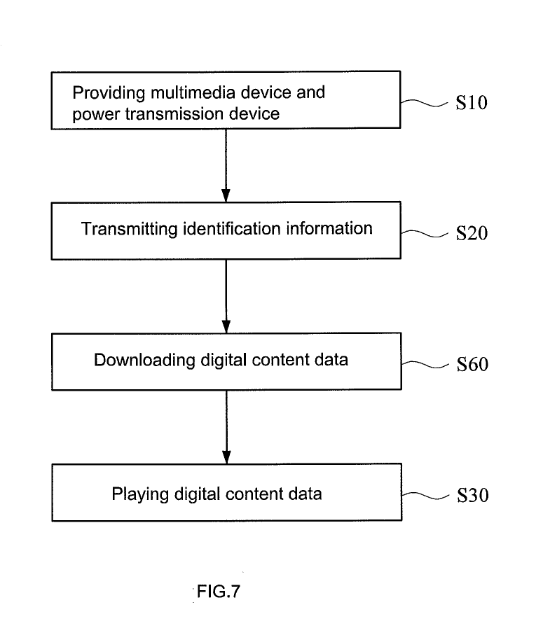

As shown in FIG. 1 to FIG. 3 and FIG. 7, after the power transmission device 20 transmits the identification information to the multimedia device 10 (step S20) and the multimedia device 10 is triggered by the identification information, before performing the step of playing the digital content data (step S30), the multimedia device 10 first determines whether it stores the digital content data. If the multimedia device 10 does not store the digital content data, the multimedia broadcasting method may further include downloading the digital content data (step S60). The multimedia device 10 connects the multimedia server 30 according to the contents of the identification information, and downloads the digital content data corresponding to the identification information from the multimedia server 30.

Similarly, the multimedia device 10 may be installed with the multimedia broadcasting application program 12 in advance. After the multimedia device 10 receives the identification information, the multimedia broadcasting application program 12 is triggered to connect to the multimedia server 30 to download and then play the digital content data.

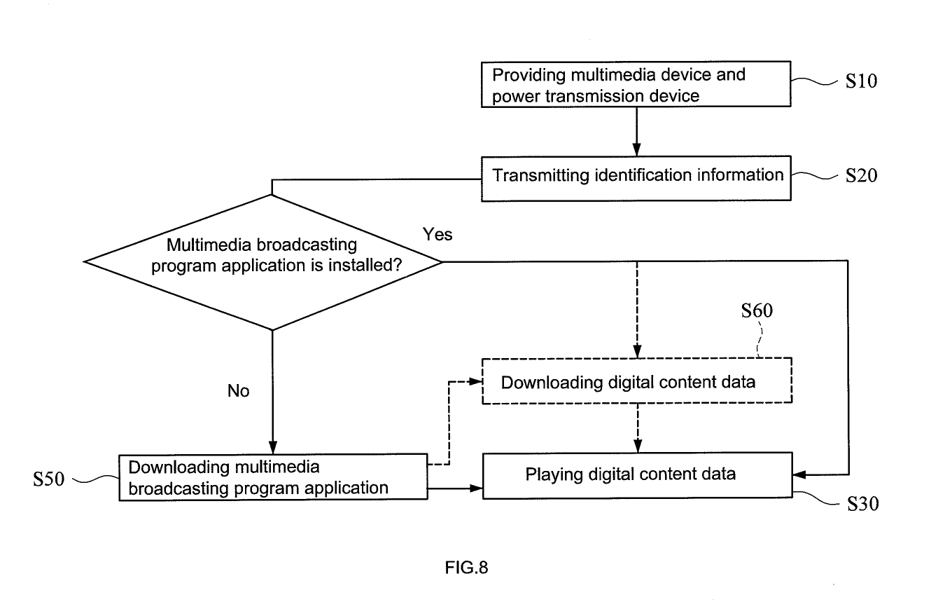

As shown in FIG. 1 to FIG. 3 and FIG. 8, if the multimedia device 10 is not installed with the multimedia broadcasting application program 12, the multimedia broadcasting method may further include downloading the multimedia broadcasting application program 12 (step S50). After the multimedia device 10 receives the identification information and before the step of downloading the digital content data (step S60) or playing the digital content data (step S30), the multimedia device 10 first determines whether it is installed with the multimedia broadcasting application program 12. If the multimedia device 10 is installed with the multimedia broadcasting application program 12, the step of downloading the digital content data (step S60) or playing the digital content data (step S30) is performed.

If the multimedia device 10 is not installed with the multimedia broadcasting application program 12, the multimedia device 10 may connect to the cloud application server 40, download the multimedia broadcasting application program 12 from the cloud application server 40 (step S50), and perform the step of downloading the digital content data (step S60) or playing the digital content data (step S30).

With the implementation of the above embodiments, when the discharging connector 21 is connected to the multimedia device 10 (i.e. a charging operation), the power transmission device 20 immediately transmits the identification information to the multimedia device 10 to trigger the multimedia device 10 to play the corresponding digital content data. When the discharging connector 21 is connected to the multimedia device 10, the power transmission device 20 may also selectively charge the multimedia device 10 at the same time, or does not charge the multimedia device 10 but only triggers the multimedia device 10 to play digital content data such as advertisements and music, thereby achieving a novel multimedia broadcasting method.

In general, the multimedia device 10 is mostly in an idle state while the power transmission device 20 charges the multimedia device 10. Therefore, with the implementation of the above embodiments, different types of information may be provided by the multimedia device 10 to a user during the idle period while the multimedia device 10 is being charged.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multimedia broadcasting system triggered by a charging operation, comprising:
a multimedia device; and
a power transmission device, having a discharging connector and a control unit, wherein,
the discharging connector, being adapted to connect to the multimedia device; and
the control unit, electrically signally connected to the discharging connector, configured to transmit readable identification information to the multimedia device via the discharging connector to trigger the multimedia device to play digital content data corresponding to the identification information.

2. The multimedia broadcasting system triggered by a charging operation according to claim 1, wherein the digital content data comprises at least one of advertisement data and music data.

3. The multimedia broadcasting system triggered by a charging operation according to claim 1, wherein the power transmission device is a power transmission line, a power adapter, a power bank, a fixed charger, a travel power transmission device, or a vehicle power transmission device.

4. The multimedia broadcasting system triggered by a charging operation according to claim 1, wherein the digital content data is previously downloaded or stored into the multimedia device, or is downloaded from a multimedia server according to the received identification information by the multimedia device, and the multimedia server stores a plurality of sets of digital content data.

5. The multimedia broadcasting system triggered by a charging operation according to claim 2, wherein the digital content data is previously downloaded or stored into the multimedia device, or is downloaded from a multimedia server according to the received identification information by the multimedia device, and the multimedia server stores a plurality of sets of digital content data.

6. The multimedia broadcasting system triggered by a charging operation according to claim 4, wherein the multimedia device is installed with a multimedia broadcasting application program, and the multimedia broadcasting application program is triggered by the identification information to play the digital content data.

7. The multimedia broadcasting system triggered by a charging operation according to claim 5, wherein the multimedia device is installed with a multimedia broadcasting application program, and the multimedia broadcasting application program is triggered by the identification information to play the digital content data.

8. The multimedia broadcasting system triggered by a charging operation according to claim 6, wherein the multimedia broadcasting application program is installed in the multimedia device in advance, or is downloaded from a cloud application server to the multimedia device.

9. The multimedia broadcasting system triggered by a charging operation according to claim 7, wherein the multimedia broadcasting application program is installed in the multimedia device in advance, or is downloaded from a cloud application server to the multimedia device.

10. The multimedia broadcasting system triggered by a charging operation according to claim 1, wherein the multimedia device is a smart phone, a tablet computer or a wearable mobile device.

11. A multimedia broadcasting method triggered by a charging operation, comprising steps of:
a) providing a multimedia device and a power transmission device, wherein the power transmission device comprises a discharging connector and a control unit, and the control unit stores identification information that is readable by the multimedia device;
b) transmitting the identification information, wherein the control unit transmits the identification information to the multimedia device when the discharging connector is connected to the multimedia device; and
c) playing digital content data, wherein the identification information triggers the multimedia device to play the digital content data corresponding to the identification information.

12. The multimedia broadcasting method triggered by a charging operation according to claim 11, wherein the digital content data is previously downloaded or stored into the multimedia device.

13. The multimedia broadcasting method triggered by a charging operation according to claim 11, wherein the multimedia device is installed with a multimedia broadcasting application program, and the multimedia broadcasting application program is triggered by the identification information to play the digital content data.

14. The multimedia broadcasting method triggered by a charging operation according to claim 13, further comprising steps of:
updating the digital content data;
wherein, before playing the digital content data, the multimedia broadcasting application program compares the previously downloaded digital content data with digital content data stored in the multimedia server, and downloads the digital content data stored in the multimedia server from the multimedia server to replace the previously downloaded digital content data.

15. The multimedia broadcasting method triggered by a charging operation according to claim 11, further comprising step of:
downloading the digital content data;
wherein, before playing the digital content data, the multimedia device downloads the digital content data corresponding to the identification information from a multimedia server according to the identification information.

16. The multimedia broadcasting method triggered by a charging operation according to claim 15, wherein the multimedia device is installed with a multimedia broadcasting application program, and the multimedia broadcasting application program is triggered by the identification information to play the digital content data.

17. The multimedia broadcasting method triggered by a charging operation according to claim 13, further comprising step of:
downloading the multimedia broadcasting application program;
wherein, after the multimedia device receives the identification information, the multimedia device first determines whether it is installed with the multimedia broadcasting application program, and downloads the multimedia broadcasting application program from a cloud application server when the multimedia device is not installed with the multimedia broadcasting application program.

18. The multimedia broadcasting method triggered by a charging operation according to claim 16, further comprising step of:
downloading the multimedia broadcasting application program;
wherein, after the multimedia device receives the identification information, the multimedia device first determines whether it is installed with the multimedia broadcasting application program, and downloads the multimedia broadcasting application program from a cloud application server when the multimedia device is not installed with the multimedia broadcasting application program.

19. A power transmission device for a multimedia broadcasting system, comprising:
a discharging connector; and
a control unit, being stored with identification information, electrically signally connected to the discharging connector, configured to output the identification information via the discharging connector.

20. The power transmission device for a multimedia broadcasting system of claim 19, wherein the digital content data comprises at least one of advertisement data and music data.

21. The power transmission device for a multimedia broadcasting system of claim 19, wherein the power transmission device is a power transmission line, a power adapter, a power bank, a fixed charger, a travel power transmission device, or a vehicle power transmission device.
